(19) United States
(12) Patent Application Publication
(10) Pub. No.: US 2012/0185111 A1
(43) Pub. Date: Jul. 19, 2012

(54) MULTIPLE-MODE DATA ACQUISITION SYSTEM

(75) Inventors: William Leisenring, Tecumseh, MI (US); Naga Puttagunta, Northville, MI (US); Nathan Nantais, Windsor (CA)

(73) Assignee: CONTROL-TEC, LLC, Allen Park, MI (US)

(21) Appl. No.: 13/352,076

(22) Filed: Jan. 17, 2012

Related U.S. Application Data
(63) Continuation-in-part of application No. 13/134,660, filed on Jun. 14, 2011.
(60) Provisional application No. 61/461,538, filed on Jan. 18, 2011.
(60) Provisional application No. 61/513,933, filed on Aug. 1, 2011.

(51) Int. Cl. G06F 7/00

(52) U.S. Cl. 701/1

(57) ABSTRACT

Disclosed is electronic control unit data recorder readable code which is configured for storage in memory of an electronic control unit data recorder, such as a vehicle data recorder. The code is configured to provide that the electronic control unit data recorder acquires data in a plurality of different modes.

### RELATED APPLICATIONS

### Priority Claim

This application claims the benefit of U.S. Provisional Application Ser. No. 61/461,538, filed Jan. 18, 2011, claims the benefit of U.S. Provisional Application Ser. No. 61/513,947, filed Aug. 1, 2011, and is a continuation-in-part of U.S. patent application Ser. No. 13/134,660, filed Jun. 14, 2011, all of which are hereby incorporated herein by reference in their entirety.

### REFERENCE TO COMPACT DISCS (CD-R'S) FILED WITH PARENT APPLICATION

Duplicate compact discs (CD-R's) were filed with parent application Ser. No. 13/134,660 as a computer program listing appendix. Each compact disc contains the following files: “seldloggerCode” (24 KB, created Jan. 14, 2011) and “uploadDataCode” (50 KB, created Jan. 14, 2011). The material on the compact discs is incorporated herein by reference.

### COPYRIGHT NOTICE

A portion of the disclosure of this patent application (including the files contained on the compact discs) contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### BACKGROUND

The present invention generally relates to electronic control unit data recorders, such as vehicle data recorders.

A vehicle data recorder is a recording device which is present in a vehicle and which receives information from various electronic control units which are present in the vehicle. Each of the electronic control units controls one or more of the electrical systems or subsystems in the vehicle. Examples of some of the electronic control units which may be present in a vehicle include, but are not limited to, an airbag control unit, an engine control unit, a seat control unit, a speed control unit, and a transmission control unit. The vehicle data recorder receives information from the various electronic control units, and stores the information in memory and/or transmits the information wirelessly to a remote location. This information can be used for various purposes, for example to assess the function and performance of a pre-production or post-production vehicle, or to manage a fleet of vehicles.

A typical vehicle data recorder that is sufficiently intelligent to receive proprietary information from a vehicle is configured to only work with a specific vehicle configuration, such as a specific make and model of vehicle which has a certain engine and transmission, certain emission systems, as well as certain electronic control unit hardware/software configurations. Specifically, the vehicle data recorder has a configuration stored therein which dictates how the vehicle data recorder collects and processes data received from the electronic control units. The configuration which is stored in the vehicle data recorder is vehicle-specific. Therefore, to manage a fleet of vehicles, where the fleet includes vehicles of various configurations such as various makes and models of vehicles, one must employ a plurality of different vehicle data recorders.

### SUMMARY

The present invention is directed at providing an electronic control unit data recorder which is automated and efficient. Specifically, an embodiment of the present invention provides an electronic control unit data recorder, such as a vehicle data recorder, which is configured to provide multiple data acquisition tools in a single piece of hardware by having data acquisition software that is capable of acquiring data in different modes.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a block diagram of a fleet management system which employs a plurality of electronic control unit data recorders, each of which is in accordance with an embodiment of the present invention;

FIG. 2 provides a high level diagram of each of the electronic control unit data recorders shown in FIG. 1;

FIGS. 3-5 provide flowcharts regarding the automated configuration deployment, management, selection, error-handling and configuring of each of the electronic control unit data recorders shown in FIG. 1;

FIG. 6 provides a block diagram of the electronic control unit data recorder, as well as some external components of the overall system; and

FIG. 7 provides a table of sample electronic control unit data recorder diagnostic codes (V-Codes).

### DETAILED DESCRIPTION OF AN ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

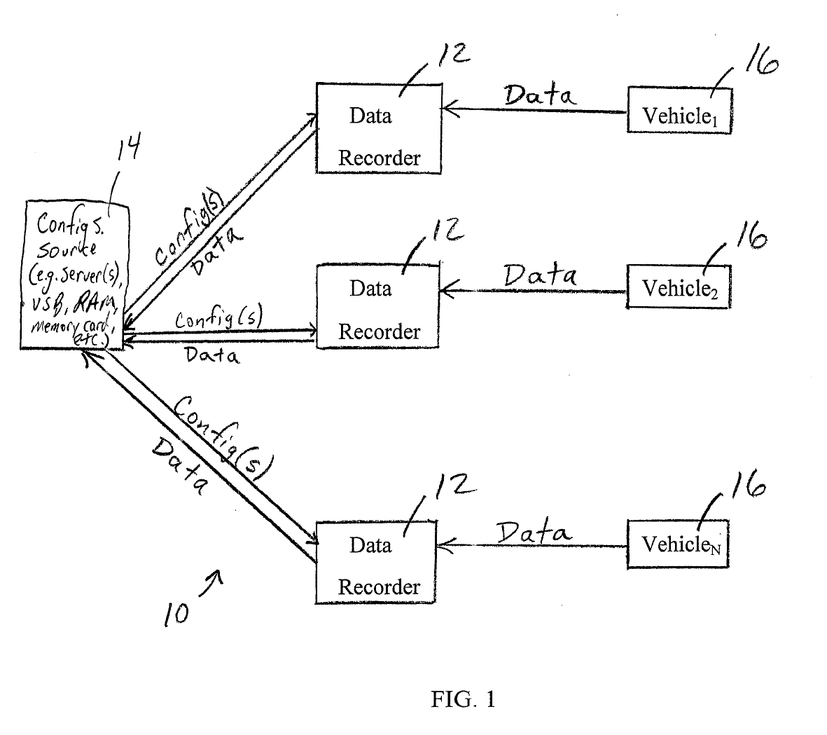

FIG. 1 illustrates a fleet management system 10 which employs a plurality of electronic control unit data recorders 12, wherein each of the electronic control unit data recorders 12 is identical and in accordance with an embodiment of the present invention. Each of the electronic control unit data recorders 12 contains code in its memory which provides, as shown in FIG. 1, that the electronic control unit data recorder 12 receives a plurality of configurations from one or more servers 14 and stores the configurations in memory. Each of the configurations which is received and stored in the memory of the electronic control unit data recorder 12 relates to, for example, a different vehicle configuration, wherein the configuration is specific with regard to several factors, such as the make of the vehicle, the exact level of model year, as well as the exact engine, transmission, emission systems, and electronic control unit hardware/software, etc. embodied in the vehicle.

The code stored in the memory of the electronic control unit data recorder 12 provides that thereafter the electronic control unit data recorder 12 can be interfaced with a vehicle 16 (in FIG. 1, the vehicles 16 are identified with “Vehicle₁”, “Vehicle₂”, . . . “Vehicle_{N}”, thereby indicating that each of the vehicles can be of a different configuration (i.e., a different configuration with regard to the make of the vehicle, the exact level of model year, as well as the exact engine, transmission, emission systems, and electronic control unit hardware/software, etc. embodied in the vehicle), and the electronic control unit data recorder 12 receives information from the vehicle 16 which allows the electronic control unit data recorder 12 to identify the exact configuration of the vehicle 16. Based on the identification, the electronic control unit data recorder 12 effectively selects one of the configurations stored in memory to use in connection with data collection and processing vis-à-vis the electronic control units of the vehicle 16. The electronic control unit data recorder 12 may also store in memory a default configuration which can be used whenever the electronic control unit data recorder 12 is unable to identify the exact configuration of a given vehicle.

Alternatively, the code stored in the memory of the electronic control unit data recorder 12 can be configured such that the electronic control unit data recorder 12 receives information from the vehicle 16 which allows the electronic control unit data recorder 12 to identify the exact configuration of the vehicle 16 and then based on the identification, the electronic control unit data recorder 12 retrieves the correct configuration from the one or more servers 14 and stores the configuration in memory for subsequent use in connection with data collection and processing vis-à-vis the electronic control units of the vehicle 16.

Still further, instead of having to obtain one or more configurations from a remote location such as from one or more servers 14, a plurality of configurations may be pre-stored in the memory of the electronic control unit data recorder 12. As such, as shown in FIG. 1, reference numeral 14 can refer to any appropriate source for the configurations, such as one or more remote servers, a USB port on the electronic control unit data recorder 12, RAM of the electronic control unit data recorder 12, a memory card (such as an SD card) of the electronic control unit data recorder 12, etc. Regardless, preferably thereafter the electronic control unit data recorder 12 receives information from the vehicle 16 which allows the electronic control unit data recorder 12 to identify the exact configuration of the vehicle 16. Based on the identification, the electronic control unit data recorder 12 subsequently uses the correct configuration in connection with data collection and processing vis-à-vis the electronic control units of the vehicle 16.

Regardless, the code stored in the memory of the electronic control unit data recorder 12 provides that once the electronic control unit data recorder 12 selects a configuration, the electronic control unit data recorder 12 thereafter collects data from various electronic control units and processes the data pursuant to the configuration. The configuration also dictates what data is stored by the electronic control unit data recorder 12, as well as also possibly what data is transmitted by the electronic control unit data recorder 12 to a remote location.

Preferably, the code stored in the memory of the electronic control unit data recorder 12 provides that the electronic control unit data recorder can communicate with the server(s) 14 and dynamically update at least one of its stored configurations, thereby providing an electronic control unit data recorder 12 having a dynamic configuration.

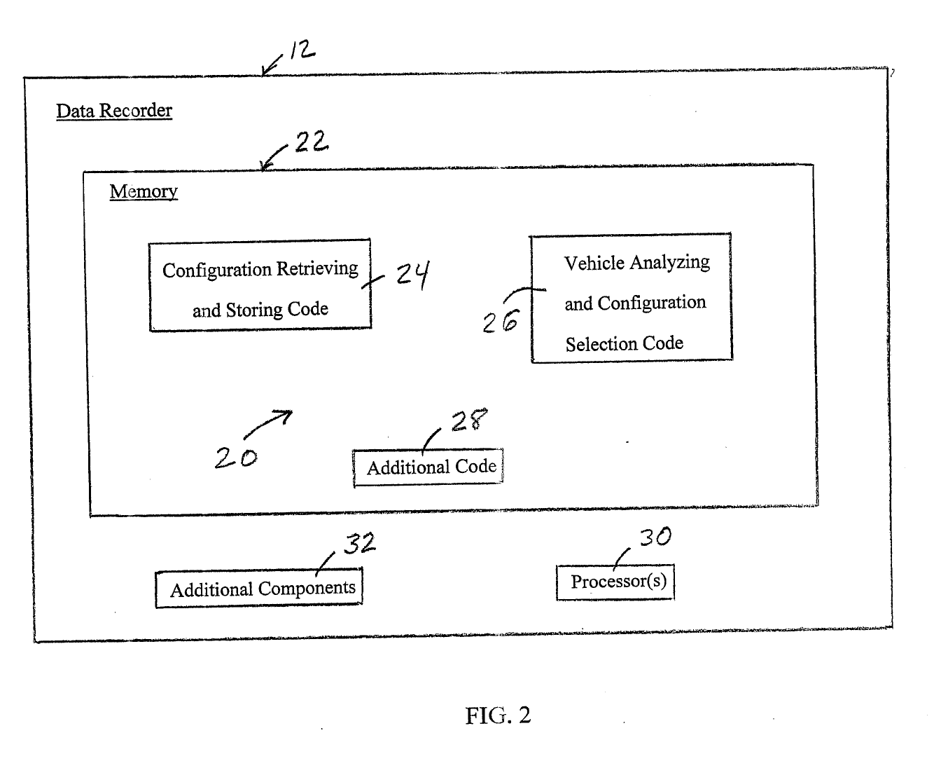

FIG. 2 provides a high level diagram of the electronic control unit data recorder 12, including the code 20 which is stored in the memory 22 of the electronic control unit data recorder 12, wherein the code is in accordance with a preferred embodiment of the present invention with other embodiments being entirely possible. As shown, a preferred embodiment of the present invention provides that the code 20 which is stored in memory 22 preferably includes configuration retrieving and storing code 24, which provides that the electronic control unit data recorder 12 receives a plurality of configurations from one or more servers 14 (see FIG. 1) and stores the configurations in memory 22. As shown, the code 20 which is stored in memory 22 also preferably includes vehicle analyzing and configuration selection code 26, which provides that the electronic control unit data recorder 12 receives information from a vehicle 16 (see FIG. 1) which allows the electronic control unit data recorder 12 to identify the exact configuration of the vehicle 16. Thereafter, based on the identification, the electronic control unit data recorder 12 effectively selects one of the configurations stored in memory 22 to use in connection with data collection and processing vis-à-vis the electronic control units of the vehicle 16. As shown, the code which is stored in memory also preferably includes additional code 28, including data acquisition code, which additionally dictates and controls the operation and functionality of the electronic control unit data recorder 12. As shown in FIG. 2, in addition to the memory 22 and code 20 stored therein, the electronic control unit data recorder 12 also includes one or more processors 30 as well as additional components 32 which are relevant to the operation and functionality of the electronic control unit data recorder 12.

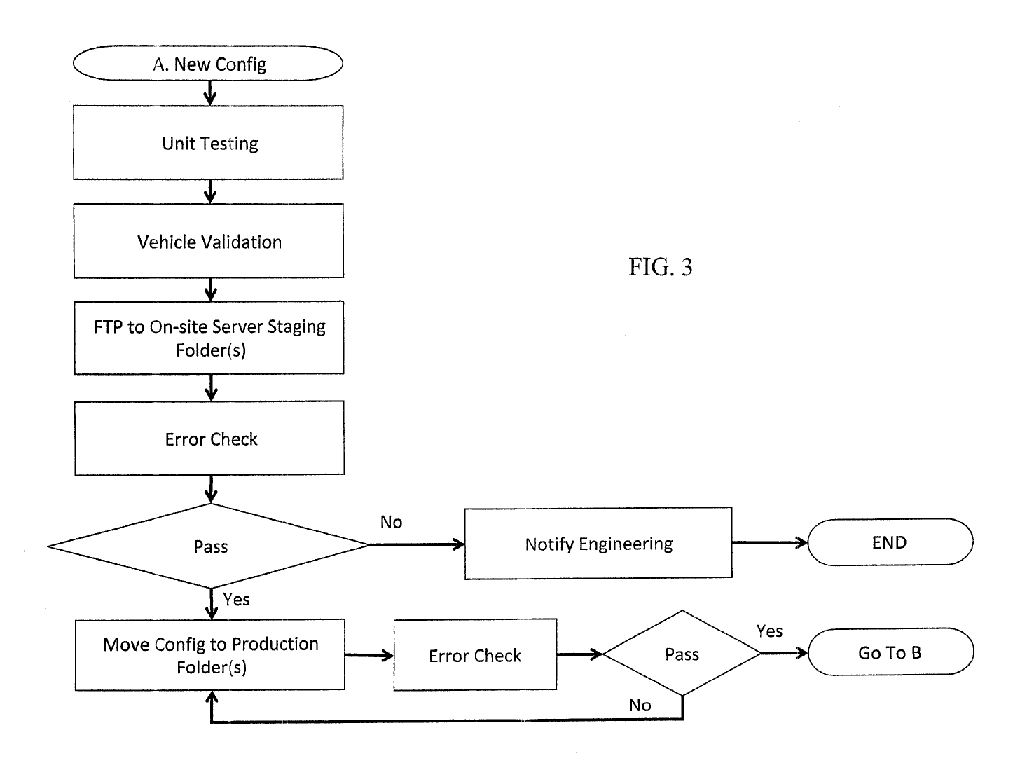

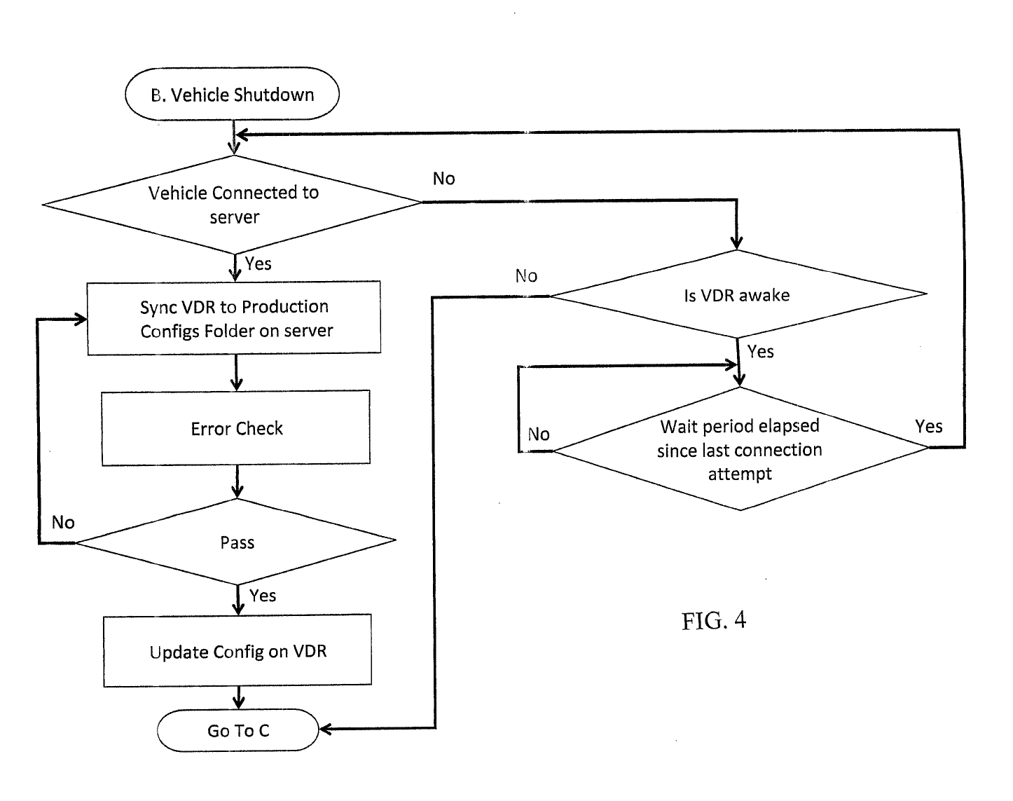

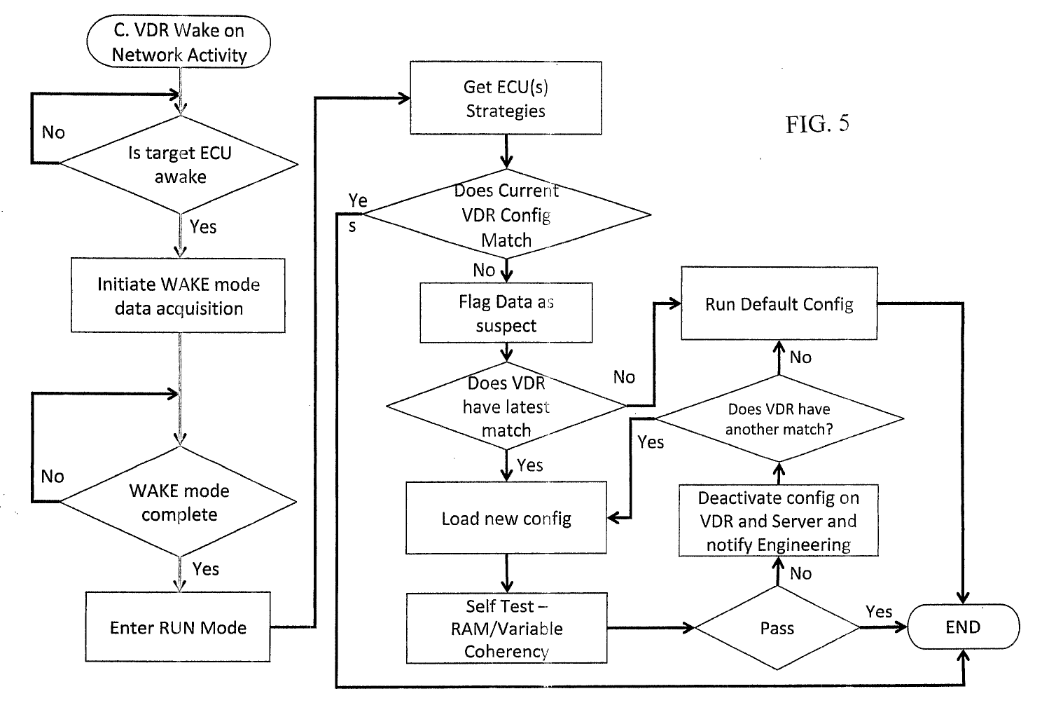

FIGS. 3-5 provide flowcharts regarding the automated configuration deployment, management, selection, error-handling and configuring of the electronic control unit data recorder 12 (and each of the electronic control unit data recorders 12 shown in FIG. 1), and are self-explanatory.

Preferably, the code 20 which is stored in the memory 22 of the electronic control unit data recorder 12 is configured such that the electronic control unit data recorder 12 robustly performs automated vehicle data acquisition and management. In contrast, conventional methods depend on the user to physically setup the system and then deploy it. This type of system is then not robust with regard to any changes that may occur in its test environment which would result in the acquisition of non-useable data.

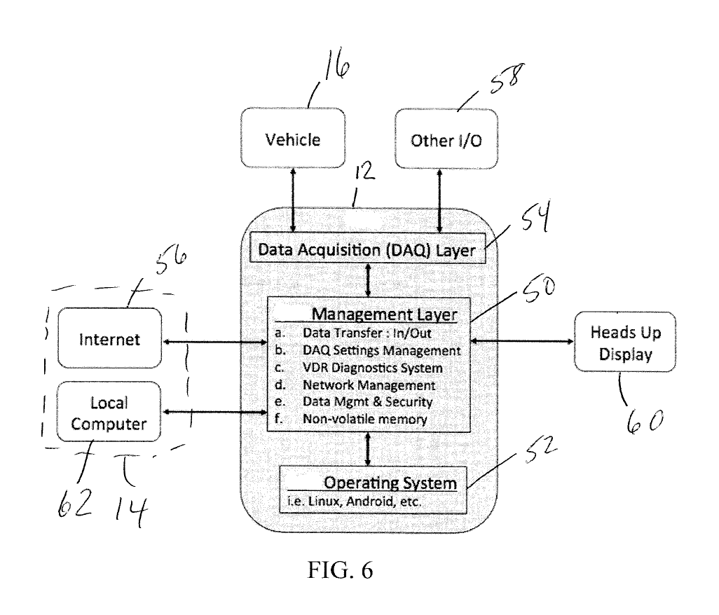

As described above, and as shown in FIG. 2 in addition to configuration retrieving and storing code 24 and vehicle analyzing and configuration selection code 26, the memory 22 of the electronic control unit data recorder 12 contains additional code 28. Some of that additional code 28 is further described with reference to FIG. 6. This additional code provides that the electronic control unit data recorder 12 is configured to acquire data, as well as contains code for data management, data transfer, data acquisition settings, a diagnostic system and preferably more. The additional code may include what may be called the “Management Layer” 50 which runs as a program stored in the memory of the electronic control unit data recorder 12, and additional code which may be called the “Data Acquisition Layer” 54. Preferably, the Management Layer 50 is configured to have the flexibility to be uploaded remotely from the server 14 via an interne connection 56 either in a manual or automated fashion.

As shown in FIG. 6, the electronic control unit data recorder 12 may also be in communication with other I/O 58, and may be connected to a heads up display or display device 60 as well as a local computer 62.

Regardless, preferably the Management Layer 50 includes code which is configured to provide the following:

a) data transfer in and out of the electronic control unit data recorder 12, where the data can be data acquired and recorded by the electronic control unit data recorder 12, diagnostic data relating to the electronic control unit data recorder 12, Data Acquisition (DAQ) configuration files relating to the electronic control unit data recorder 12, and/or management configuration files relating to the electronic control unit data recorder 12;

b) a DAQ Settings Management function, where the data acquisition protocol, supported data and/or the corresponding DAQ configuration file is automatically determined;

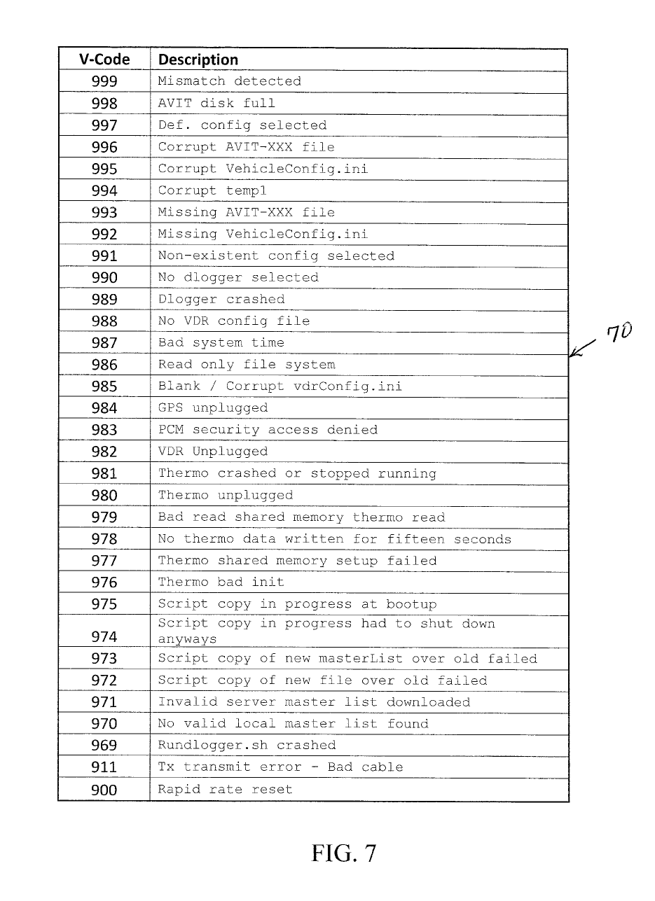

c) that the diagnostics system of the electronic control unit data recorder 12 monitors the performance of the electronic control unit data recorder 12 to ensure that useful data is being recorded at all times. FIG. 7 provides a table 70 of sample electronic control unit data recorder diagnostic codes (V-Codes).

d) network management handles all connectivity to the electronic control unit data recorder 12 via a local computer 62 or the Internet 56. Preferably, this function can automatically select among available local, WiFi, and/or supported cellular networks. More specifically, preferably the electronic control unit data recorder 12 is configured to logically decide whether to transmit data via WiFi, transmit data via a cellular network, or whether to store the data locally on local physical removable data storage, such as on a removable USB drive, in order to prevent the internal memory of the electronic control unit data recorder 12 from becoming so full that the electronic control unit data recorder 12 no longer acquires data. This function is also responsible for logical access control to different areas of the software system of the electronic control unit data recorder;

e) data management and security, which is responsible for all data storage and data security; and

f) that data is recorded on non-volatile memory, where that data is preferably stored in between power-on times of the electronic control unit data recorder, to enable proper function of the DAQ Layer 54 and Management Layer 50.

As discussed above, and as shown in FIG. 2 in addition to configuration retrieving and storing code 24 and vehicle analyzing and configuration selection code 26, the memory 22 of the electronic control unit data recorder 12 contains additional code 28 relating to the acquisition of data, data management, data transfer, data acquisition settings, a diagnostic system and preferably more.

Preferably, the code 28 is configured such that the electronic control unit data recorder 12 is capable of acquiring data simultaneously for many different use cases or modes. These consist of, but may not be limited to the following:

a) simultaneous high speed data acquisition (i.e., faster than 1 Hz);

b) on-board synthetic data parameters as a function of sampled data;

c) high speed data acquisition for a trigger, based on the sampled or synthetic data, i.e., event-based high speed trigger;

d) high speed data acquisition for a trigger based on time, i.e., time-based high speed trigger;

e) simultaneous low speed data acquisition (i.e., slower than 1 Hz);

f) low speed data acquisition while a condition is true based on the sampled or synthetic data, i.e. low speed event-based trigger;

g) low speed data acquisition while a condition is true based on time, i.e., low speed time based trigger;

h) Snapshot (i.e., one sample only) data acquisition based on an event of the sampled or synthetic data, i.e., event-based snapshot;

i) Snapshot (i.e., one sample only) data acquisition based on time, i.e., time-based snapshot;

j) On-board statistical data acquisition based on sampled or synthetic data that provides event counts, histograms, minimum, maximum, average, standard deviation, variance, signal-to-noise ratio, frequency, and more;

k) dynamically change subsequently sampled or synthetic data based on the currently sampled or synthetic data or other input for a calibrateable number of samples or time period;

l) real-time data broadcasted to user from vehicle through Qualifier system. User can change which parameters are broadcasted from the vehicle via the Qualifier website; and/or

m) all of the above modes are applied to all available electronic control units of the vehicle which are accessible by the electronic control unit data recorder 12.

While an electronic control unit vehicle recorder which is useable with a plurality of different types of vehicles has been described above, an electronic control unit vehicle recorder which is in accordance with an embodiment of the present invention may instead by configured for use with only one type of vehicle, but which is capable of acquiring or transmitting data in different modes.

Additionally, while the present disclosure specifically discusses a vehicle data recorder as being the type of electronic control unit data recorder with which the present invention is utilized, the present invention can be implemented in many other types of devices and systems. For example, the present invention can be used to manage a fleet of boats, a plurality of bridges, or really anything which is capable of being monitored and/or controlled by one or more electronic control units.

While a specific embodiment of the present invention is shown and described, it is envisioned that those skilled in the art may devise various modifications without departing from the spirit and scope of the present invention.

What is claimed is:

1. Code which is readable by an electronic control unit data recorder, wherein the code is configured to provide that the electronic control unit data recorder acquires data from at least one electronic control unit in different modes.

2. Code as recited in claim 1, wherein the code is configured to provide that the electronic control unit data recorder acquires data from a plurality of electronic control units simultaneously.

3. Code as recited in claim 2, wherein the code is configured to provide that the electronic control unit data recorder acquires data at a speed which is faster than 1 Hz.

4. Code as recited in claim 2, wherein the code is configured to provide that the electronic control unit data recorder acquires data at a speed which is slower than or equal to 1 Hz.

5. Code as recited in claim 1, wherein the code is configured to provide that the electronic control unit data recorder acquires data from at least one electronic control unit for a trigger, based on an event detected by electronic control unit data recorder by analyzing sampled or synthetic data.

6. Code as recited in claim 1, wherein the code is configured to provide that the electronic control unit data recorder acquires data from at least one electronic control unit based on time.

7. Code as recited in claim 1, wherein the code is configured to provide that the electronic control unit data recorder acquires data from at least one electronic control unit while a condition is true, said condition being determined by the electronic control unit data recorder by analyzing sampled or synthetic data.

8. Code as recited in claim 1, wherein the code is configured to provide that the electronic control unit data recorder acquires data from at least one electronic control unit while a condition is true based on time, said condition being determined by the electronic control unit data recorder by analyzing sampled or synthetic data.

9. Code as recited in claim 1, wherein the code is configured to provide that the electronic control unit data recorder acquires data from at least one electronic control unit in a snapshot (i.e., a single sample only) based on an event, said event being determined by the electronic control unit data recorder by analyzing sampled or synthetic data.

10. Code as recited in claim 1, wherein the code is configured to provide that the electronic control unit data recorder acquires data from at least one electronic control unit in a snapshot (i.e., a single sample only) based on time.

11. Code as recited in claim 1, wherein the code is configured to provide that the electronic control unit data recorder performs on-board statistical data acquisition based on sampled or synthetic data and provides at least one of event counts, histograms, minimum, maximum, average, standard deviation, variance, signal-to-noise ratio, and frequency.

12. Code as recited in claim 1, wherein the code is configured to provide that the electronic control unit data recorder dynamically changes subsequently sampled or synthetic data based on the currently sampled or synthetic data or other input for a calibrateable number of samples or time period.

13. Code as recited in claim 1, wherein the code is configured to provide that the electronic control unit data recorder is configured to revise on-board synthetic data parameters as a function of sampled data.

14. Code as recited in claim 1, wherein the code is configured to provide that the electronic control unit data recorder is configured to transmit data to a remote user, wherein the code is configured such that the remote user can change what data is transmitted and the parameters relating to the data transmitted.

15. Code as recited in claim 1, wherein the code is configured to provide that the electronic control unit data recorder acquires data from a plurality of electronic control units in a plurality of different modes.
